(19) United States
(12) Patent Application Publication
(10) Pub. No.: US 2021/0075461 A1
(43) Pub. Date: Mar. 11, 2021

(54) SIGNAL PROCESSING METHOD AND CIRCUIT OF MOBILE TERMINAL AND MOBILE TERMINAL

(71) Applicant: ZTE CORPORATION, Shenzhen, Guangdong (CN)

(72) Inventor: Bin LEI, Shenzhen, Guangdong (CN)

(21) Appl. No.: 16/644,804

(22) PCT Filed: May 24, 2018
(86) PCT No.: PCT/CN2018/088235

§ 371 Date: Mar. 5, 2020

(30) Foreign Application Priority Data
Sep. 6, 2017 (CN) 201710797523.7

(51) Int. Cl. H04B 1/44; H04B 1/401

(52) U.S. Cl. CPC H04B 1/44; H04B 1/401

(57) ABSTRACT

A signal processing method and circuit of a mobile terminal and a mobile terminal are provided, by sending a signal detected by operating an antenna body as a sensing pad of a sensor to a microprocessor, the microprocessor determines a usage state of the mobile terminal according to the signal, generates a control signal according to the usage state of the mobile terminal, and controls a tuning circuit to switch tuning paths through the control signal so as to perform a tuning process on a signal from a mobile terminal signal source or the antenna body.

### TECHNICAL FIELD

The present disclosure relates to the field of communication, and in particular, to a signal processing method and circuit of a mobile terminal, and a mobile terminal.

### BACKGROUND

With continuous development of communication technology, portable mobile terminals such as mobile phones and notebooks have become essential personal belongings for almost everyone. In a process of designing a mobile terminal, various parameters required for design are obtained usually based on performance designed in a free space mode (that is, the mobile terminal is placed in the free space), and antenna performance of the mobile terminal is designed based on the parameters. Thus, after the design of the mobile terminal is completed, the antenna performance of the mobile terminal is determined. However, in a process of using the mobile terminal, a using environment of the mobile terminal is significantly different from a free space environment, for example, when the mobile terminal is used, external factors such as holding the mobile terminal by a hand of a user and approaching the mobile terminal to a head of the user may cause deterioration of the antenna performance, and finally, user experience is affected.

### SUMMARY

The following is a summary of a subject matter described in detail herein. This summary is not intended to limit the scope of the claims.

Embodiments of the present disclosure provide a signal processing method and circuit of a mobile terminal and a mobile terminal.

According to an embodiment of the present disclosure, there is provided a signal processing circuit of a mobile terminal including an antenna body, a sensor connected with the antenna body, a microprocessor and a tuning circuit having a plurality of tuning paths. The tuning circuit is connected between a mobile terminal signal source and the antenna body, and the microprocessor is connected with the sensor and the tuning circuit, respectively. The sensor is configured to send a signal detected by operating the antenna body as a sensing pad of the sensor to the microprocessor. The microprocessor is configured to receive the signal, determine a usage state of the mobile terminal according to the signal, generate a control signal according to the usage state of the mobile terminal, and control the tuning circuit to switch the tuning paths through the control signal to perform a tuning process on a signal from the mobile terminal signal source or the antenna body.

In an exemplary embodiment, the signal processing circuit further includes an isolation device which is a lumped inductive element, and the sensor is connected with the antenna body through the isolation device. The isolation device is configured to isolate interference of a communication signal on the signal detected by the sensor.

In an exemplary embodiment, the sensor is a capacitive proximity sensor.

In an exemplary embodiment, the tuning circuit includes a tuning path T1 and a tuning path T2, the tuning path T1 includes inductors L1 and L2, and capacitors C3 and C4, one end of the inductor L2 is connected with one stationary contact of a first switch element, and one end of the capacitor C3 is connected with a signal feed point of the antenna body. The tuning path T2 includes inductors L3 and L4, and capacitors C5 and C6, one end of the inductor L4 is connected to one stationary contact of the first switch element, and one end of the capacitor C5 is connected with the signal feed point of the antenna body.

In an exemplary embodiment, the signal processing circuit includes a second switch element, the mobile terminal signal source includes a radio frequency circuit and a baseband processing circuit. A grounding point GND1 and a grounding point GND2 of the antenna body are respectively connected with two stationary contacts of the second switch element. Control ends of the first switch element and the second switch element are both connected with one end of the microprocessor, and the other end of the microprocessor is connected with the sensor. A moving contact of the first switch element is connected with one end of the radio frequency circuit, the other end of the radio frequency circuit is connected with the baseband processing circuit, and a moving contact of the second switch element is grounded.

In an exemplary embodiment, the tuning paths have a well-type circuit structure, a T-type circuit structure, or a n-type circuit structure.

According to another embodiment of the present disclosure, a mobile terminal including any of above signal processing circuits is provided.

According to another embodiment of the present disclosure, a signal processing method of a mobile terminal is provided.

The signal processing method includes: detecting a signal by operating an antenna body of the mobile terminal as a sensing pad of a sensor; determining a usage state of the mobile terminal according to the signal; and performing a tuning process on a signal from a mobile terminal signal source or the antenna body according to the usage state of the mobile terminal.

In an exemplary embodiment, determining the usage state of the mobile terminal according to the signal includes: detecting a change condition of a capacitance as a human body approaches through the sensor and the antenna body of the mobile terminal; and determining the usage state of the mobile terminal according to the change condition.

In an exemplary embodiment, performing the tuning process on the signal from the mobile terminal signal source or the antenna body according to the usage state of the mobile terminal includes: performing the tuning process on the signal from the mobile terminal signal source or the antenna body by switching a tuning circuit of the mobile terminal to a corresponding tuning path, in which the mobile terminal is provided with the tuning circuit having a plurality of tuning paths, and each tuning path corresponds to one usage state of the mobile terminal.

According to another embodiment of the present disclosure, a storage medium is further provided, the storage medium includes a stored program, any of above signal processing methods is performed when the program is executed.

According to another embodiment of the present disclosure, a processor is further provided, the processor is configured to run a program, any of above signal processing methods is performed when the program is executed.

According to the present disclosure, by sending the signal detected by operating the antenna body as a sensing pad of the sensor to the microprocessor, the microprocessor determines the usage state of the mobile terminal according to the signal, generates the control signal according to the usage state of the mobile terminal, and controls the tuning circuit to switch tuning paths according to the control signal to perform the tuning process on the signal from the mobile terminal signal source or the antenna body. A problem is solved that a current antenna signal processing circuit occupies more space due to a fact that a sensing pad connected with the sensor needs to be independently arranged in order to ensure that an antenna system is automatically switched to an optimal state to improve quality of antenna signals, an occupied internal space of the mobile terminal is reduced, interference to a communication antenna is avoided and user experience is improved.

Other aspects will be apparent after reading and understanding the accompanying drawings and the detailed description.

### BRIEF DESCRIPTION OF THE DRAWINGS

FIG. 1 is a block diagram of a hardware structure of a mobile terminal performing a signal processing method according to an embodiment of the present disclosure;

FIG. 2 is a structural block diagram of a signal processing circuit according to an embodiment of the present disclosure;

FIG. 3 is a structural block diagram of a signal processing circuit according to an exemplary embodiment of the present disclosure;

FIG. 4 is a schematic diagram of a signal processing circuit according to an exemplary embodiment of the present disclosure;

FIG. 5 is a flowchart of a signal processing method of a mobile terminal according to an embodiment of the present disclosure;

FIG. 6 is a flowchart of a signal processing method according to an embodiment of the present disclosure; and

FIG. 7 is a structural block diagram of a mobile terminal according to an embodiment of the present disclosure.

### DETAILED DESCRIPTION

At present, a smart watch and an antenna signal processing circuit thereof are disclosed, the antenna signal processing circuit includes a sensor module, a microprocessor, an antenna body and an antenna tuning circuit having a plurality of tuning paths, in which a wearing state of the smart watch is determined by using a proximity sensing signal detected by the sensor module, and then the antenna tuning circuit is switched to a tuning path corresponding to the wearing state, so that an antenna system is suitable for the current wearing state, the antenna system is guaranteed to be automatically switched to an optimal state, and quality of antenna signals is improved. The sensor module is one or more of a distance sensor, a temperature sensor and an acceleration sensor, and requires additional supporting elements and supporting circuits.

There is no solution provided for a problem that the antenna signal processing circuit occupies more space due to a fact that a sensing pad connected with the sensor needs to be independently arranged in order to ensure that the antenna system is automatically switched to an optimal state to improve the quality of the antenna signals.

The present disclosure will be described in detail below with reference to accompanying drawings in conjunction with embodiments.

The terms “first,” “second,” and the like in the description and claims of the present disclosure and in the foregoing accompanying drawings are used to distinguish between similar elements and not necessarily for describing a particular sequence or chronological order.

### Example 1

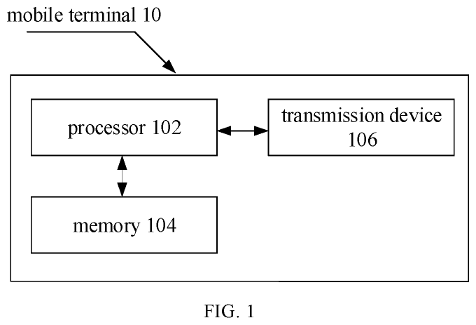

A method embodiment provided in example 1 of the present disclosure may be performed in a mobile terminal, a computer terminal or a similar computing device. Taking the mobile terminal as an example, FIG. 1 is a block diagram of a hardware structure of a mobile terminal performing a signal processing method according to an embodiment of the present disclosure. As shown in FIG. 1, a mobile terminal 10 may include one or two processors 102 (only one processor 102 is shown in FIG. 1) which may include, but are not limited to, a processing device such as a microprocessor MCU or a programmable logic device FPGA, a memory 104 for storing data, and a transmission device 106 for performing communication functions. It will be understood by those skilled in the art that the structure shown in FIG. 1 is only an illustration and is not intended to limit the structure of the mobile terminal. For example, the mobile terminal 10 may include more or fewer components than those shown in FIG. 1, or have a configuration different from that shown in FIG. 1.

The memory 104 may be used to store software programs and modules of an application, such as program instructions/modules corresponding to a signal processing method according to an embodiment of the present disclosure, and the processor 102 executes various functional applications and data processes by running the software programs and the modules stored in the memory 104, so as to implement the method described above. The memory 104 may include a high speed random memory, and may also include a non-volatile memory, such as one or two magnetic memory devices, flash memory, or other non-volatile solid-state memory. In some instances, the memory 104 may further include a memory located remotely from the processor 102 which may be connected to the mobile terminal 10 via a network. Examples of the network include, but are not limited to, an internet, an intranet, a local area network, a mobile communication network, and a combination thereof.

The transmission device 106 is used to receive or transmit data via a network. Specific examples of the network described above may include a wireless network provided by a communication provider of the mobile terminal 10. In one example, the transmission device 106 includes a network interface controller (NIC) which can be connected to other network apparatuses through a base station so as to communicate with the internet. In one example, the transmission device 106 may be a radio frequency (RF) module which is used to communicate with the internet in a wireless manner.

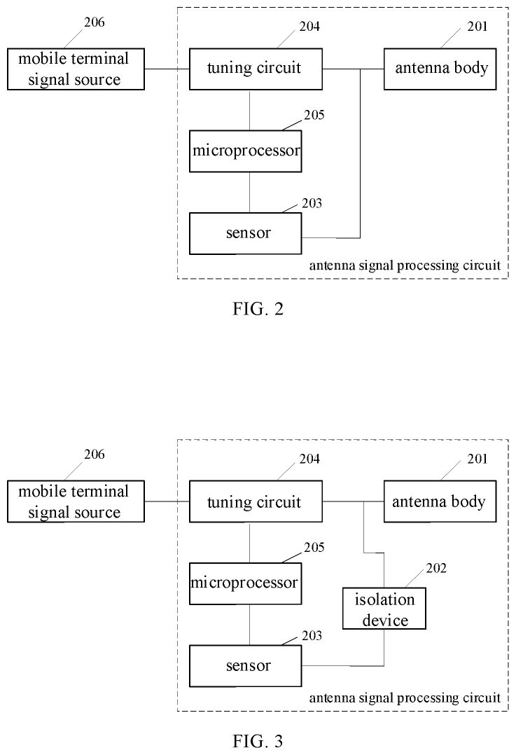

According to an embodiment of the present disclosure, there is provided a signal processing circuit of a mobile terminal which is applied to the mobile terminal described above. FIG. 2 is a structural block diagram of a signal processing circuit according to an embodiment of the present disclosure. As shown in FIG. 2, the signal processing circuit includes an antenna body 201, a sensor 203 connected with the antenna body 201, a microprocessor 205, a tuning circuit 204 having a plurality of tuning paths.

The tuning circuit 204 is connected between a mobile terminal signal source 206 and the antenna body 201, and the microprocessor 205 is connected with the sensor 203 and the tuning circuit 204, respectively.

The sensor 203 is configured to send a signal detected by operating the antenna body 201 as a sensing pad of the sensor 203 to the microprocessor 205.

The microprocessor 205 is configured to receive the signal, determine a usage state of the mobile terminal according to the signal, generate a control signal according to the usage state of the mobile terminal, and control the tuning circuit 204 to switch the tuning paths through the control signal to perform a tuning process on a signal from the mobile terminal signal source 206 or the antenna body 201.

FIG. 3 is a structural block diagram of a signal processing circuit according to an exemplary embodiment of the present disclosure. As shown in FIG. 3, the circuit further includes an isolation device 202 which is a lumped inductive element. The sensor 203 is connected to the antenna body 201 through the isolation device 202, and the isolation device 202 is configured to isolate interference of a communication signal to the signal detected by the sensor 203.

In an exemplary embodiment, the sensor 203 may be a capacitive proximity sensor.

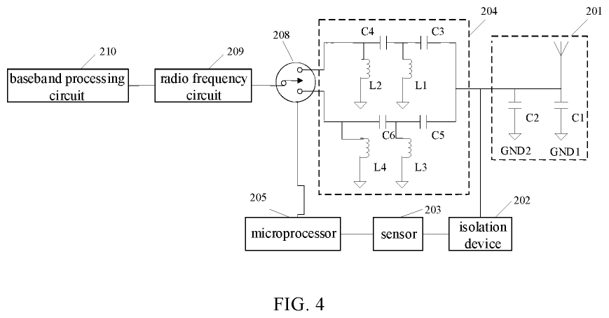

FIG. 4 is a schematic diagram of a signal processing circuit according to an exemplary embodiment of the present disclosure. As shown in FIG. 4, the tuning circuit 204 includes a tuning path T1 and a tuning path T2, the tuning path T1 includes inductors L1 and L2, and capacitors C3 and C4, one end of the inductor L2 is connected to one stationary contact of a first switch element 208, and one end of the capacitor C3 is connected to a signal feed point of the antenna body 201.

The tuning path T2 includes inductors L3 and L4, and capacitors C5 and C6, one end of the inductor L4 is connected to the other one stationary contact of the first switch element 208, and one end of the capacitor C5 is connected to the signal feed point of the antenna body 201.

In an exemplary embodiment, the circuit may include a second switch element, the mobile terminal signal source 206 includes a radio frequency circuit 209 and a baseband processing circuit 210.

A grounding point GND1 and a grounding point GND2 of the antenna body 201 are respectively connected with two stationary contacts of the second switch element.

Control ends of the first switch element 208 and the second switch element are both connected with one end of the microprocessor 205, and the other end of the microprocessor 205 is connected with the sensor 203.

A moving contact of the first switch element 208 is connected with one end of the radio frequency circuit 209, the other end of the radio frequency circuit 209 is connected with the baseband processing circuit 210, and a moving contact of the second switch element is grounded.

In an exemplary embodiment, the tuning paths may have a well-type circuit structure, a T-type circuit structure, or a IL-type circuit structure.

As shown in FIG. 4, the signal processing circuit includes the antenna body 201, the isolation device 202, the sensor 203, the tuning circuit 204 having a plurality of tuning paths, the microprocessor 205, and the mobile terminal signal source 206. The antenna body 201 is connected with the sensor 203 through the isolation device 202, the tuning circuit 204 is connected between the mobile terminal signal source 206 and the antenna body 201, and the microprocessor 205 is connected with the sensor 203 and the tuning circuit 204, respectively. The sensor 203 detects an approach signal of an external human body through the antenna body 201 and sends the detected signal to the microprocessor 205, the microprocessor 205 receives the signal and generates a control signal according to the signal, and controls the tuning circuit 204 to switch the tuning paths through the control signal to perform the tuning process on the signal from the mobile terminal signal source 206 or the antenna body 201.

The sensor 203 adopts a capacitive proximity sensor 203, when a human body is close to/contacts the antenna body 201, since the human body is equivalent to a grounded capacity, a capacity may be formed between the antenna body 201 and the ground, and induced capacitance usually has several pF to tens pF. A circuit of the sensor 203 outputs a pulse signal to charge and discharge the capacity formed between the antenna body 201 and the ground, and whether or not the human body approaches or touches the antenna body 201 is detected based on a change in the capacitance.

The isolation device 202 adopts a lumped inductive element with an inductance value greater than 100 nH. By isolation of the lumped inductance element, the interference of the communication signal to the detected signal of the sensor 203 is isolated.

In the embodiment, one tuning path of the tuning circuit 204 corresponds to one usage state of the mobile terminal. In an implement, possible usage states of the mobile terminal should be determined firstly (which may be determined statistically through experiments), and then matching impedances of the tuning paths of the tuning circuit 204 are determined, so that one tuning path of the tuning circuit 204 corresponds to one usage state of the mobile terminal.

In the embodiment, by arranging the sensor 203, the usage state of the mobile terminal is determined by using the signal detected by the antenna body 201, and then the tuning circuit 204 is switched to a corresponding tuning path, so that a system of the mobile terminal is suitable for the current usage state. In the embodiment, the antenna body 201 is connected with the sensor 203 through the isolation device 202 to detect the change in the capacitance between the antenna body 201 and the ground caused when human body is close to/contacts the antenna body 201, thereby avoiding independently arranging a sensing pad to be connected with the sensor 203, thus, a space occupied by arranging the sensing pad is reduced. Meanwhile, interference of the sensing pad to communication is avoided and communication quality is improved. As shown in FIG. 4, the signal processing circuit includes the antenna body 201, the isolation device 202, the sensor 203, the tuning circuit 204 having a plurality of tuning paths, the microprocessor 205, the radio frequency circuit 209, the baseband processing circuit 210, and the first switch element 208. The first switch element 208 includes the control end, the moving contact, and the stationary contacts.

Based on the above assumption of the embodiment, accordingly, the tuning circuit 204 includes two tuning paths, i.e., the tuning path T1 and the tuning path T2. Exemplarily, as shown in FIG. 4, the tuning path T1 includes inductors L1 and L2, and capacitors C3 and C4, one end of the inductor L2 is connected to one of the stationary contacts of the first switch element 208, and one end of the capacitor C3 is connected to the signal feed point of the antenna body 201; the tuning path T2 includes inductors L3 and L4, and capacitors C5 and C6, one end of the inductor L4 is connected to the other one of the stationary contacts of the first switch element 208, and one end of the capacitor C5 is connected to the signal feed point of the antenna body 201.

FIG. 4 only exemplarily illustrates the tuning paths with a well-type circuit structure, the circuit structure of the tuning paths is not limited in the embodiment, and the tuning paths may be designed to have a T-type circuit structure, a n-type circuit structure, or the like. The embodiment further includes a second switch element (not shown in FIG. 4) which also includes the control end, the moving contact and the stationary contacts. Correspondingly, the antenna body 201 includes one signal feed point and two grounding points which are the grounding point GND1 and the grounding point GND2, respectively.

In the embodiment, one end of the tuning path T1 and one end of the tuning path T2 are connected to the signal feed point of the antenna body 201, respectively, the other end of the tuning path T1 and the other end of the tuning path T2 are connected to the two stationary contacts of the first switch element 208, respectively, and the grounding point GND1 and the grounding point GND2 of the antenna body 201 are connected to the two stationary contacts of the second switch element, respectively; the control ends of the first switch element 208 and the second switch element are both connected with one end of the microprocessor 205, and the other end of the microprocessor 205 is connected with the sensor 203; the moving contact of the first switch element 208 is connected to one end of the radio frequency circuit 209, the other end of the radio frequency circuit 209 is connected to the baseband processing circuit 210, and the moving contact of the second switch element is grounded.

The microprocessor 205 of the embodiment adjusts system performance of the mobile terminal based on the control signal as follows: the sensor 203 sends a detected change signal of a system capacitance to the microprocessor 205, and the microprocessor 205 determines the current usage state of the mobile terminal according to the signal and generates a corresponding control signal according to the current usage state of the mobile terminal.

As previously assumed, the usage state in the embodiment includes a state of using, a state of free space, a state of holding by a hand of a user, and a state of approaching by the head of a user, so that the microprocessor 205 can generate a high level or a low level to control the switching of the first switch element 208 and the switching of the second switch element by using the high level or the low level. In this case, the first switch element 208 and the second switch element may be single-pole double-throw switches controlled by high and low levels inputted through the control end.

Exemplarily, it is assumed that the microprocessor 205 determines that the mobile terminal is currently in the state of holding by a hand of a user, accordingly, the microprocessor 205 generates the high level to control the control ends of the first switch element 208 and the second switch element, to control the moving contact of the first switch element 208 to contact with the stationary contact connecting with the tuning path T2, and to control the moving contact of the second switch element to contact with the stationary contact connecting with the grounding point GND1, so that to perform the tuning process on the signal from the antenna body 201 or a transmission signal from the baseband processing circuit 210 by using a matching impedance of the tuning path T1 and to adjust and improve radiation performance of the antenna body 201 in the state of holding by a hand of a user by using the grounding point GND2.

### Example 2

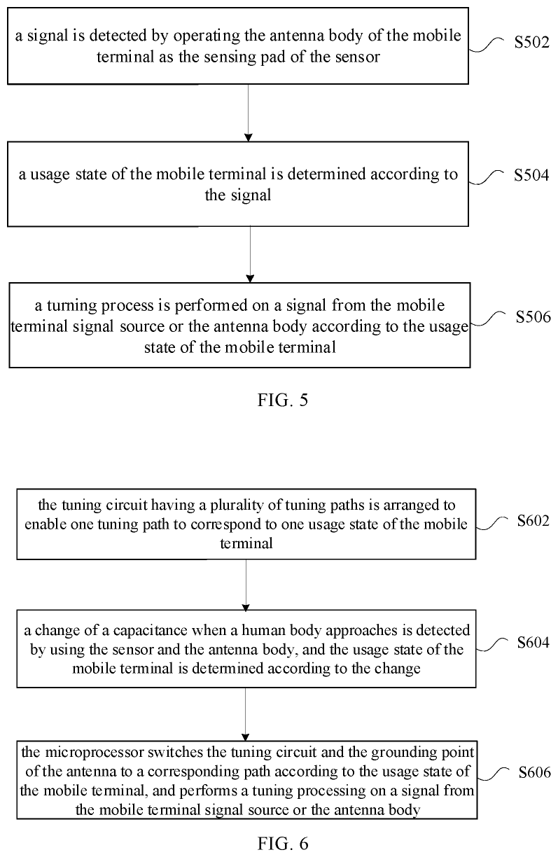

In an embodiment of the present disclosure, a signal processing method of a mobile terminal is provided. FIG. 5 is a flowchart of a signal processing method of a mobile terminal according to an embodiment of the present disclosure. As shown in FIG. 5, the flowchart includes the following steps S502 to S506.

In step S502, a signal is detected by operating the antenna body 201 of the mobile terminal as a sensing pad of the sensor 203.

In step S504, a usage state of the mobile terminal is determined according to the signal.

In step S506, a tuning process is performed on a signal from the mobile terminal signal source 206 or the antenna body 201 according to the usage state of the mobile terminal.

Through the above steps, the antenna body 201 of the mobile terminal is operated as the sensing pad of the sensor 203 to detect a signal, and the usage state of the mobile terminal is determined according to the signal, and the tuning process is performed on the signal from the mobile terminal signal source 206 or the antenna body 201 according to the usage state of the mobile terminal, so that the problem is solved that a current antenna signal processing circuit occupies more space due to a fact that a sensing pad connected with the sensor 203 needs to be independently arranged in order to ensure that an antenna system is automatically switched to an optimal state to improve quality of antenna signals, an occupied internal space of the mobile terminal is reduced, interference to a communication antenna is avoided and user experience is improved.

In an exemplary embodiment, determining the usage state of the mobile terminal according to the signal may include: a change condition of a capacitance as a human body approaches is detected through the sensor 203 and the antenna body 201 of the mobile terminal, and the usage state of the mobile terminal is determined according to the change condition.

In an exemplary embodiment, performing the tuning process on the signal from the mobile terminal signal source 206 or the antenna body 201 according to the usage state of the mobile terminal may include: the tuning process is performed on the signal from the mobile terminal signal source 206 or the antenna body 201 by switching the tuning circuit 204 of the mobile terminal to a corresponding tuning path, the mobile terminal is provided with the tuning circuit 204 having a plurality of tuning paths, and each tuning path corresponds to one usage state of the mobile terminal. The mobile terminal is internally provided with the antenna body 201, the sensor 203 connected with the antenna body 201, the microprocessor 205 and the tuning circuit 204 having a plurality of tuning paths, and the method includes the following steps: the sensor 203 detects a signal by operating the antenna body 201 as the sensing pad and determines the usage state of the mobile terminal according to the signal; arranging the tuning circuit 204 having a plurality of tuning paths such that one tuning path corresponds to one usage state of the mobile terminal; and switching the tuning circuit 204 to a corresponding tuning path according to the usage state of the mobile terminal, and performing the tuning process on the signal from the mobile terminal signal source or the antenna body. In the method, since a communication antenna on a module is reused as the sensing pad of the sensor 203, so that the problem of more occupied space caused by independently arranging the sensing pad connected with the sensor 203 is avoided, and interference of the sensing pad on communication is also avoided.

FIG. 6 is a flowchart of a signal processing method according to an embodiment of the present disclosure. As shown in FIG. 6, the method including steps S602 to S606.

In step S602, the tuning circuit 204 having a plurality of tuning paths is arranged to enable one tuning path to correspond to one usage state of the mobile terminal.

In step S604, a change of a capacitance as a human body approaches is detected by using the sensor 203 and the antenna body 201, and the usage state of the mobile terminal is determined according to the change.

In step S606, the microprocessor 205 switches the tuning circuit 204 and the grounding point of the antenna to a corresponding path according to the usage state of the mobile terminal, and performs a tuning processing on a signal from the mobile terminal signal source 206 or the antenna body 201.

In the embodiment, the change of the capacitance as a human body approaches is detected by using the sensor 203 and the antenna body 201, the usage state of the mobile terminal is determined according to the change, and then the tuning circuit 204 is switched to the tuning path corresponding to the usage state, so that the system of the mobile terminal is suitable for the current usage state, the system of the mobile terminal can be automatically switched to an optimal state, quality of signals is ensured, and user experience is improved.

In order to further improve performance of the mobile terminal in different usage states, the method in FIG. 6 further includes: arranging one signal feed point and a plurality of grounding points for the antenna body 201, and when or after performing the tuning process on the signal from the mobile terminal signal source or the antenna body 201, the method further includes: the grounding points of the antenna body 201 are switched to adjust performance of the antenna body 201.

In one implementation of the embodiment, the grounding points of the antenna body may be switched by arranging a switch element for the antenna body, the switch element includes a control end, a moving contact and a plurality of stationary contacts, the moving contact is grounded, one stationary contact is connected with one grounding point, each stationary contact corresponds to one usage state of the mobile terminal, and the moving contact of the switch element is switched by controlling the control end.

### Example 3

According to another embodiment of the present disclosure, there is also provided a mobile terminal including the antenna body 201, the sensor 203 connecting with the antenna body 201, the microprocessor 205, and the tuning circuit 204 having a plurality of tuning paths. The interference of the communication signal to the signal of the sensor 203 is isolated through the isolation device 202 between the antenna body 201 and the sensor 203. The microprocessor 205 detects the usage state of the mobile terminal and adjusts system parameters of the mobile terminal.

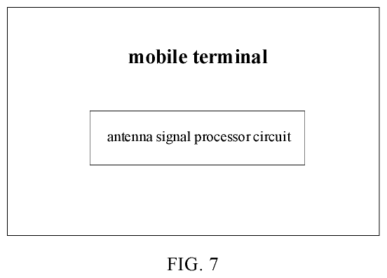

FIG. 7 is a structural block diagram of a mobile terminal according to an embodiment of the present disclosure. As shown in FIG. 7, the mobile terminal of the embodiment includes an antenna signal processing circuit, an internal structure of the antenna signal processing circuit is as shown in FIG. 3, the antenna body 201 in the antenna signal processing circuit is connected to the sensor 203 through the isolation device 202, and when a human body approaches the antenna body 201, a change of a capacitance between the antenna body 201 and the ground may be detected, and the microprocessor 205 in the antenna signal processing circuit senses whether a human body approaches, so as to adjust the system parameters of the mobile terminal.

In a design process of the embodiment, in order to save space of the mobile terminal and save components, the microprocessor 205 in the embodiment is a central controller CPU of the mobile terminal, that is, the actions such as determining, calculating, controlling or the like performed by the microprocessor 205 in the antenna signal processing circuit are performed by the central controller CPU of the mobile terminal.

Since the baseband processing circuit in the antenna signal processing circuit is also substantially one microcontroller, the baseband processing circuit in the antenna signal processing circuit may be a central processing unit CPU of the mobile terminal either.

### Example 4

Embodiments of the present disclosure also provide a storage medium including stored programs, any one of the methods described above is performed when the programs are executed.

Optionally, in the embodiment, the storage medium may be configured to store program codes for performing the following steps S11 to S13.

In step S11, a signal is detected by operating an antenna body of a mobile terminal as a sensing pad of a sensor.

In step S12, a usage state of the mobile terminal is determined according to the signal.

In step S13, a tuning process is performed on a signal from a mobile terminal signal source or the antenna body according to the usage state of the mobile terminal.

Optionally, in the embodiment, the storage medium may include, but is not limited to, various media capable of storing program codes, such as a USB disk, a read only memory (ROM), a random access memory (RAM), a removable hard disk, a magnetic disk, or an optical disk.

### Example 5

Embodiments of the present disclosure further provide a processor which is configured to run programs, the processor perform the steps in any one of the methods described above when the programs are executed.

Optionally, in the embodiment, the programs are configured to execute the following steps S21 to S23.

In step S21, a signal is detected by operating an antenna body of a mobile terminal as a sensing pad of a sensor.

In step S22, a usage state of the mobile terminal is determined according to the signal.

In step S23, a tuning process is performed on a signal from a mobile terminal signal source or the antenna body according to the usage state of the mobile terminal.

Optionally, for specific examples in the embodiment, reference may be made to the examples described in the above embodiments and optional implementations, which are not described herein again.

It will be understood by those of ordinary skill in the art that all or some of the steps of the methods, functional modules/units in the devices, systems disclosed above may be implemented as software, firmware, hardware, or suitable combinations thereof. In a hardware implementation, division between functional modules/units mentioned in the above description does not necessarily correspond to division of physical components; for example, one physical component may have multiple functions, or one function or step may be performed by several physical components in cooperation. Some or all of the components may be implemented as software executed by a processor such as a digital signal processor or a microprocessor, or implemented as hardware, or implemented as an integrated circuit such as an application specific integrated circuit. Such software may be distributed on a computer-readable media which may include computer storage media (or non-transitory media). The term “computer storage media” includes volatile and nonvolatile media, removable and non-removable media implemented in any method or technology for storage of information such as computer readable instructions, data structures, program modules or other data, as is well known to those ordinary skilled in the art. The computer storage media includes, but is not limited to, RAM, ROM, EEPROM, flash memory or other memory technologies, CD-ROM, digital versatile disk (DVD) or other optical disk storages, magnetic cassettes, magnetic tape, magnetic disk storage or other magnetic storage devices, or any other medium which can be used to store the desired information and which can be accessed by a computer.

The above description is only exemplary embodiments of the present disclosure and is not intended to limit the present disclosure, and it can be seen by those skilled in the art that various modifications and changes may be made to the present disclosure. Any modification, equivalent replacement, improvement and the like made within the principle of the present disclosure should be included in the protection scope of the present disclosure.

### INDUSTRIAL APPLICABILITY

According to the present disclosure, by sending a signal detected by operating an antenna body as a sensing pad of a sensor to a microprocessor, the microprocessor determines a usage state of the mobile terminal according to the signal, generates a control signal according to the usage state of the mobile terminal, and controls a tuning circuit to switch tuning paths according to the control signal to perform a tuning process on a signal from a mobile terminal signal source or the antenna body, a problem is solved that a current antenna signal processing circuit occupies more space due to a fact that a sensing pad connected with the sensor 203 needs to be independently arranged in order to ensure that an antenna system is automatically switched to an optimal state to improve quality of antenna signals, an occupied internal space of the mobile terminal is reduced, interference to a communication antenna is avoided and user experience is improved.

1. A signal processing circuit of a mobile terminal, comprising: an antenna body, a sensor connected with the antenna body, a microprocessor and a tuning circuit having a plurality of tuning paths,
wherein the tuning circuit is connected between a mobile terminal signal source and the antenna body, and the microprocessor is connected with the sensor and the tuning circuit, respectively,
the sensor is configured to send a signal detected by operating the antenna body as a sensing pad of the sensor to the microprocessor,
the microprocessor is configured to receive the signal, determine a usage state of the mobile terminal according to the signal, generate a control signal according to the usage state of the mobile terminal, and control the tuning circuit to switch the tuning paths through the control signal to perform a tuning process on a signal from the mobile terminal signal source or the antenna body.

2. The signal processing circuit of claim 1, wherein the signal processing circuit further comprises an isolation device which is a lumped inductive element, the sensor is connected with the antenna body through the isolation device, and
wherein the isolation device is configured to isolate interference of a communication signal on the signal detected by the sensor.

3. The signal processing circuit of claim 1, wherein the sensor is a capacitive proximity sensor.

4. The signal processing circuit of claim 1, wherein,
the tuning circuit comprises a tuning path T1 and a tuning path T2, the tuning path T1 comprises inductors L1 and L2, and capacitors C3 and C4, one end of the inductor L2 is connected with one stationary contact of a first switch element, and one end of the capacitor C3 is connected with a signal feed point of the antenna body,
the tuning path T2 comprises inductors L3 and L4, and capacitors C5 and C6, one end of the inductor L4 is connected to the other one stationary contact of the first switch element, and one end of the capacitor C5 is connected with the signal feed point of the antenna body.

5. The signal processing circuit of claim 4, wherein the signal processing circuit comprises a second switch element, the mobile terminal signal source comprises a radio frequency circuit and a baseband processing circuit, and
wherein a grounding point GND1 and a grounding point GND2 of the antenna body are respectively connected with two stationary contacts of the second switch element;
control ends of the first switch element and the second switch element are both connected with one end of the microprocessor, and the other end of the microprocessor is connected with the sensor;
a moving contact of the first switch element is connected with one end of the radio frequency circuit, the other end of the radio frequency circuit is connected with the baseband processing circuit, and a moving contact of the second switch element is grounded.

6. The signal processing circuit of claim 4 or 5, wherein the tuning paths have a well-type circuit structure, a T-type circuit structure, or a it-type circuit structure.

7. A mobile terminal comprising the signal processing circuit of claim 1.

8. A signal processing method of a mobile terminal, comprising:
detecting a signal by operating an antenna body of the mobile terminal as a sensing pad of a sensor;
determining a usage state of the mobile terminal according to the signal; and
performing a tuning process on a signal from a mobile terminal signal source or the antenna body according to the usage state of the mobile terminal.

9. The signal processing method of claim 8, wherein determining the usage state of the mobile terminal according to the signal comprises:
detecting a change condition of a capacitance as a human body approaches through the sensor and the antenna body of the mobile terminal; and
determining the usage state of the mobile terminal according to the change condition.

10. The signal processing method according to claim 8, wherein performing the tuning process on the signal from the mobile terminal signal source or the antenna body according to the usage state of the mobile terminal comprises:
performing the tuning process on the signal from the mobile terminal signal source or the antenna body by switching a tuning circuit of the mobile terminal to a corresponding tuning path,
wherein the mobile terminal is provided with the tuning circuit having a plurality of tuning paths, and each tuning path corresponds to one usage state of the mobile terminal.

11. A storage medium, wherein the storage medium comprises a stored program which cause, when executed by a processor, the processor to perform the signal processing method according to claim 8.

12. A processor, wherein the processor is configured to run a program, the signal processing method according to claim 8 is performed when the program is executed by the processor.
